(19) United States
(12) Patent Application Publication
(10) Pub. No.: US 2018/0040012 A1
(43) Pub. Date: Feb. 8, 2018

(54) VIRTUAL AND REAL MARKET COMMODITY RECOMMENDATION AND REWARD SYSTEM

(71) Applicant: LINCTRONIX LTD., New Taipei City (TW)

(72) Inventor: YU-SHUN LIN, New Taipei City (TW)

(21) Appl. No.: 15/669,045

(22) Filed: Aug. 4, 2017

(30) Foreign Application Priority Data
Aug. 5, 2016 (TW) 105124887

(51) Int. Cl. G06Q 30/02; G06Q 20/32

(52) U.S. Cl. CPC G06Q 30/0214; G06Q 20/327; G06Q 20/3224; G06Q 20/3255

(57) ABSTRACT

The present invention discloses a virtual and real market commodity recommendation and reward system for recommending a target commodity or a target location. The virtual and real market commodity recommended and reward system includes a wireless mobile device, a transaction host, and a recommendation server. The recommendation server is for generating a recommended URL about the target commodity or the target location, and the wireless mobile device is for receiving this recommended URL and sharing the recommended URL on a social media. When the second user gets the recommended URL from the social media and completes a shopping action for the target commodity or on the target location via the recommend URL, the recommendation server will provide a reward to the recommended user.

### CROSS-REFERENCE TO RELATED APPLICATIONS

This application claims priority to Taiwan Application No. 105124887, filed Aug. 5, 2016, hereby incorporated herein by reference in its entirety.

### BACKGROUND OF THE INVENTION

### Field of the Invention

The present invention relates to a commodity recommendation and reward system, and in particular the present invention relates to a virtual and real market commodity recommendation and reward system.

### Description of the Prior

In general, the recommendation of commodities and stores are linked by word of mouth, and the stores usually market the commodities via the staff hawking or sending leaflets. In order to enhance the dissemination of information and promote paperless, online commodity recommendation system began popular.

In the prior art, the online commodity recommendation system can share a recommended identifier by a recommender to a new applicant to generate a link relationship. When the new applicant uses the recommended identifier to buy commodities on the online commodity recommendation system, the recommender gets a reward. The online commodity recommendation system promotes the online commodity in such a way that the new applicant generates the link relationship to the recommender via the recommended identifier.

In the other prior art, the online commodity recommendation system shares a recommended URL by the recommender. The new applicant uses the recommended URL to enter the online commodity recommendation system, and after the application process to become the online commodity recommendation system members. When the new applicant uses the online commodity recommendation system to buy a commodity, the recommender gets a reward. This recommendation and reward mechanism encourages the recommender to promote the spread of the online commodity recommendation system, and the new applicant takes the initiative to generate the link relationship to the recommender.

Whether it is to share the identifier or the applicant URL, it cannot effectively convey the recommender who want to recommend the commodity information, and in the system only a single on the line relationship. When the new applicant shops, only the first recommender can enjoy the reward mechanism, resulting in the second recommender will not actively recommend commodities and stores. This will perform the online commodity recommendation system only a one-time circulation, resulting in the recommended commodity information cannot be effectively conveyed.

Thus, the above-mentioned prior art is not a good design, and a lot of missing still needs to be improved. In view of the above, the present invention will provide a non-single line way of a virtual and real market commodity recommendation and reward system.

### SUMMARY OF THE INVENTION

The invention is to provide a virtual and real market commodity recommendation and reward system. In an embodiment of the present invention, the virtual and real market commodity recommendation and reward system of present invention is to provide at least one first user to recommend a recommended commodity message by a sharing mechanism, and when at least one second user gets the recommendation commodity and generates a recommended transaction, the present invention provides a reward to the first user. The virtual and real market commodity recommendation and reward system comprises a first wireless mobile device, a transaction host, and a recommendation server. Wherein, the first wireless mobile device has a transaction application executing thereon, and when the first user buys the recommended commodity and pays it via the transaction application, the transaction application sends a consumption message to the transaction host via the first wireless mobile device, and the transaction host sends a transaction code to the recommendation server after completing the recommended commodity transaction. Then, the recommendation server generates a recommended URL and sends the recommended URL to the transaction application. Wherein, the first user can send the transaction recommended URL to the second user by the sharing mechanism, and when the second user uses the recommended commodity message via the transaction recommended URL to complete a recommended transaction, the first user gets the reward. Wherein, the sharing mechanism selectively pushes the transaction recommended URL to the second user or posts the transaction recommended URL on an exclusive page of the network media.

According to the embodiment of the present invention, the virtual and real market commodity recommendation and reward system of present invention provides the consumers a recommend sharing mechanism and a commodity evaluating mechanism to other consumer references after a consumer completes the real transaction, and then provides the reward mechanism to the original consumer when the other consumer consumes based on the recommended sharing, which finally achieves the purpose of combining the virtual and real shopping.

Compared with the prior art, the virtual and real market commodity recommendation and reward system uses a user's experience to sharing a recommended commodity or location to a social media, and when a friend consumes based on the recommended commodity or location of the sharing mechanism, the user obtains the reward. The virtual and real market commodity recommendation and reward system makes the information circulate effectively e and promotes the motive of the shopping by the characteristic of the friends' trust.

The advantages and spirits of the invention can be understood by the following recitations together with the appended drawings.

### BRIEF DESCRIPTION OF THE APPENDED DRAWINGS

FIG. 1 shows a recommendation schematic diagram of the first embodiment of the virtual and real market commodity recommendation and reward system of the present invention.

FIG. 2 shows a recommendation function block diagram of the first embodiment of the virtual and real market commodity recommendation and reward system of the present invention.

FIG. 3 shows a reverse payment schematic diagram of the first embodiment of the virtual and real market commodity recommendation and reward system of the present invention.

FIG. 4 shows a recommendation schematic diagram of the second embodiment of the virtual and real market commodity recommendation and reward system of the present invention.

FIG. 5 shows a recommendation function block diagram of the second embodiment of the virtual and real market commodity recommendation and reward system of the present invention.

FIG. 6 shows a reward function block diagram of the first embodiment of the virtual and real market commodity recommendation and reward system of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

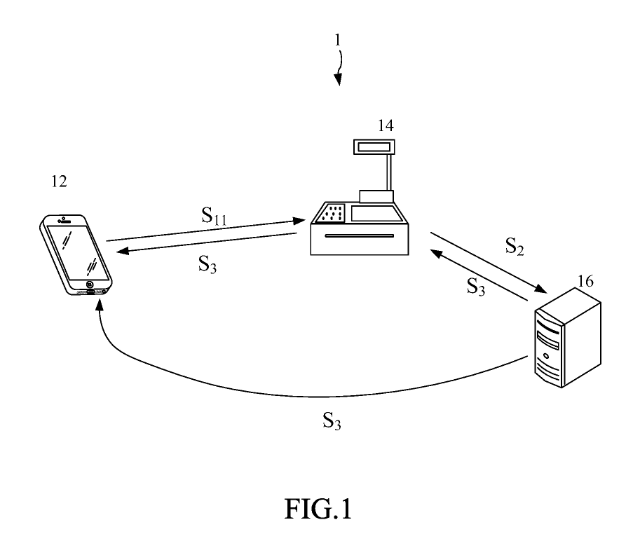

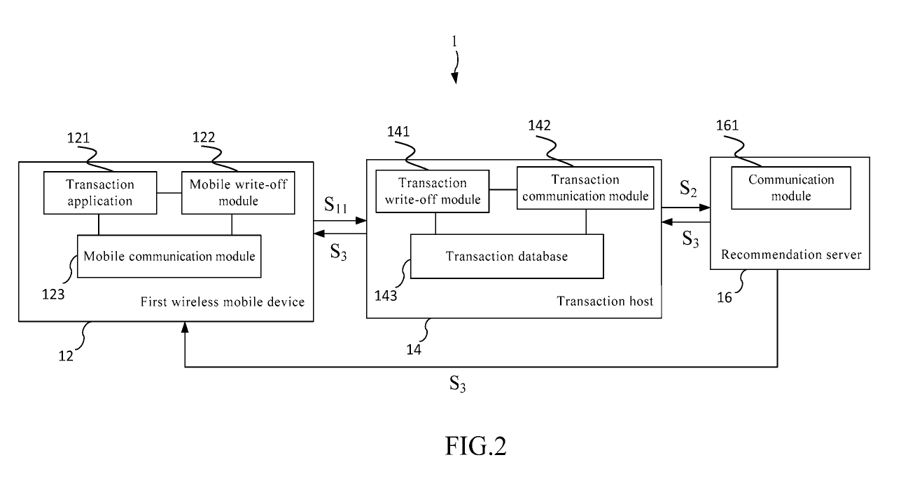

Please refer to FIG. 1 and FIG. 2; FIG. 1 shows a recommendation schematic diagram of the first embodiment of the virtual and real market commodity recommendation and reward system 1 of the present invention, and FIG. 2 shows a recommendation function block diagram of the first embodiment of the virtual and real market commodity recommendation and reward system 1 of the present invention. In the first embodiment of the present invention, the virtual and real market commodity recommendation and reward system 1 provides at least one first user to recommend a recommended commodity message by a sharing mechanism, wherein, the recommended commodity message comprises a recommended commodity, and when at least one second user performs a recommended transaction by using the recommended commodity message, the virtual and real market commodity recommendation and reward system 1 provides a reward to the first user, wherein, the virtual and real market commodity recommendation and reward system 1 comprises a first wireless mobile device 12, a transaction host 14, and a recommendation server 16. The first wireless mobile device 12 has a transaction application 121 executing thereon, for providing the first user to buy the recommended commodity and to pay it via the transaction application 121 to the transaction host 14. In the course of the transaction or after the completion of the transaction, the transaction application 121 sends a consumption message S11 to the transaction host 14. When the transaction host 14 confirms that the transaction is complete, the transaction host 14 sends a transaction code S2 to the recommendation server 16. Then, the recommendation server 16 generates a recommended URL S3 after receiving the transaction code S2, and sends the recommended URL S3 to the transaction application 121. Wherein, the first user can send the transaction recommended URL S3 to the second user by the sharing mechanism via a network media. And, when the second gets the recommended URL S3 and uses the recommended URL S3 to complete a recommended transaction, the first user gets the reward. Wherein, the sharing mechanism can selectively push the transaction recommended URL to the second user or post the transaction recommended URL on an exclusive page of the network media.

In the first embodiment of the present invention, the consumption message comprises the following information: a unique consumer identifier corresponding to the first wireless mobile device 12, and a transaction payment message, wherein, the transaction payment message is the message required for a transaction payment mechanism. In the present invention, the transaction payment mechanism is selected from one of the following mechanisms: NFC (Near Field Communication) HCE (Host Card Emulation) action payment mechanism, NFC Tokenization mobile payment mechanism, QR (Quick Response) Code mobile payment service, and Bluetooth action payment and write-off, wherein the QR code action payment service can be Alipay, WeChat payment, Paypal Payment, China Telecom QR Code and other QR code as a payment platform for payment tools. The payment and write-off form of the transaction payment mechanism can be selected from any of the following: action or network of electronic wallet payment, mobile credit card payment, financial card payment, payment card payment, virtual currency payment, third party payment, vouchers write off, coupon write off, bonus points write off, set point exchange write-off or commodity voucher write-off. The transaction payment information of the transaction payment mechanism can be selected from any of the following: an electronic wallet account, a telecommunications account, a mobile credit card, an action prepaid card, a mobile debit card, a banknote account, a bank action account, a third party payment action account, an action ticket coupon, an action voucher, a set points for offset consumption, a set points for exchange commodity, virtual currency or any information that can be used as an action financial transaction or a write-off.

In the first embodiment of the present invention, the first wireless mobile device 12 comprises a mobile write-off module 122, wherein, the mobile write-off module 122 has a wireless communication function. The transaction host 14 comprises a transaction write-off module 141, wherein, the transaction write-off module 141 has a wireless communication function. The wireless communication function of the mobile write-off module 122 and the transaction write-off module 141 is selected from any of the following communication methods: Bluetooth, wireless local area network, NFC cards, NFC reads, two-dimensional bar code (QR Code) display, two-dimensional bar code (QR Code) scanning, or other similar wireless network communication module. In the practical application, the transaction application 121 sends the consumption message S11 to the transaction host 14 to perform the method of: the transaction application 121 of the first wireless mobile device 12 transmits the consumption message S11 by the wireless information exchange between the mobile write-off module 122 and the transaction write-off module 141, and then pay the transaction and follow-up recommended action.

In the practical application, the wireless information is exchanged between the mobile write-off module 122 and the transaction write-off module 141 to perform the method of: the transaction application 121 of the first wireless mobile device 12 establishes a wireless information exchange channel via the mobile write-off module 122 and the transaction write-off module 141 to transmit the message.

In the first embodiment of the present invention, if the wireless information exchange channel of the mobile write-off module 122 and the transaction write-off module 141 performs in the Bluetooth method, the mobile write-off module 122 and the transaction write-off module 141 are the Bluetooth mobile module and the Bluetooth endpoint module, respectively. If the wireless information exchange channel performs in the wireless area network method, the mobile write-off module 122 and the transaction write-off module 141 are the Wi-Fi mobile module and the Wi-Fi endpoint module, respectively. If the wireless information exchange channel performs in the NFC cards method, the mobile write-off module 122 and the transaction write-off module 141 are the NFC cards mobile module and the NFC reads endpoint module, respectively. If the wireless information exchange channel performs in the NFC reads method, the mobile write-off module 122 and the transaction write-off module 141 are the NFC reads mobile module and the NFC cards endpoint module, respectively. If the wireless information exchange channel performs in the QR Code method, the mobile write-off module 122 and the transaction write-off module 141 are the display mobile module and the camera endpoint module, respectively. If the wireless information exchange channel performs in the QR Code scans method, the mobile write-off module 122 and the transaction write-off module 141 are the camera mobile module and the display endpoint module, respectively.

The wireless information exchange channel of the present invention performing can be selected from any of the following: in the form of the Bluetooth, wherein, the Bluetooth mobile module can establish a Bluetooth connection with the Bluetooth endpoint module and use the Bluetooth connection as the wireless information exchange channel; or the Bluetooth mobile module sends a Bluetooth broadcast message, and the Bluetooth endpoint module scans and receives the Bluetooth broadcast message as the wireless information exchange channel; or the Bluetooth endpoint module sends a Bluetooth broadcast message, and the Bluetooth mobile device module scans and receives the Bluetooth broadcast message as the wireless information exchange channel. The wireless information exchange channel of the present invention also can be performed in wireless area network, wherein, the Wi-Fi mobile module and the Wi-Fi endpoint module are connected to the same Wi-Fi AP (access point) or different Wi-Fi AP, respectively, but the Wi-Fi AP can be connected to each other via a wireless or wired network, and the Wi-Fi mobile module and the Wi-Fi endpoint establish a Wi-Fi connection as the wireless information exchange channel. The wireless information exchange channel of the present invention also can be performed in NFC cards; wherein, the NFC cards mobile module is set to NFC card mode and the NFC reads endpoint module is set to NFC reader mode, and the NFC cards mobile module and the NFC reads endpoint module via the NFC contactless payments method are served as the wireless information exchange channels. The wireless information exchange channel of the present invention also can be performed in NFC reads; wherein, the NFC reads mobile module is set to NFC reader mode and the NFC cards endpoint module is set to card mode; and the NFC reads mobile module and the NFC cards endpoint module via the NFC contactless payments method are served as the wireless information exchange channels. The wireless information exchange channel of the present invention also can be performed in QR Code; wherein, the display mobile module displays a set of QR code comprising information content and the camera endpoint module scans the QR Code, and then the QR Code image display and scanning is used as a wireless data exchange channel. The wireless information exchange channel of the present invention also can be performed in QR Code scanning; wherein, the camera mobile module scans a QR code that is displayed on the display endpoint module, and then the QR Code image display and scanning are served as a wireless data exchange channel.

In the first embodiment of the present invention, the transaction code S2 comprises the following information: a unique consumer identifier corresponding to the first wireless mobile device 12, a transaction payment message and a transaction identifier. Wherein, the transaction identifier can be an identification code of the real transaction within the transaction host 14, or a code that is encoded by one or more transaction parameters. The recommendation server 16 can use the identification code of the real transaction to query the transaction host 14 for the transaction record to obtain the transaction parameters. In the present invention, the transaction parameters are selected from one or more of the following types of messages: the preferential message, the transaction amount, the location code, the transaction time, the traded commodity message, etc. Wherein, the commodity message is a commodity code, a commodity or service identifier, a commodity or service offer message, a commodity or service name, a commodity or service provider name, quantity, unit price, etc., provided by the transaction host 14. The transaction parameters contained in the transaction code S2 can further comprise multiple commodity messages. At the time of transmission, the transaction code S2 can be further encrypted or encoded in a manner conforming to the transmission specification.

Wherein, the transaction host 14 further comprises a transaction database 143 that records the transaction parameters of the transaction at each transaction, the transaction parameters comprising the preferential message, the transaction amount, the location code, the transaction time and the traded commodity message. Wherein, the transaction host 14 further provides a query transaction record function. And, when the recommendation server 16 uses the transaction identifier to reverse query, the transaction database 143 provides the preferential message, the transaction amount, the location code, the transaction time, the traded commodity message, etc., which are represented by the transaction parameters corresponding to the transaction identifier.

In embodiments of the present invention, the location code can be selected from any of the following: a store code, a shop code, a GPS coordinate system location, an Apple iBeacon code and a Google Eddystone code. Wherein, the store code and the shop code correspond to a particular store, a store name, or information that determines the store or the shop. The transaction host 14 can use the store code or shop code to query the built-in information or the recommendation server 16 to know the store and shop name and information represented by the code. The GPS coordinate system location is the latitude and longitude of the location of the global satellite positioning system. The Apple iBeacon code and the Google Eddystone code can query the recommendation server 16 for the location name and information. In an embodiment of the present invention, the location code can also be a virtual location code representing a website.

In the first embodiment of the present invention, the transaction host further comprises a transaction communication module 142, and the first wireless mobile device 12 further comprise a mobile communication module 123. Wherein, the mobile communication module 123 comprises one or more of the following communication functions: a mobile communication protocol module or a wireless area network (Wi-Fi) module. Wherein, the transaction communication mobile comprises one or more of the following communication functions: a mobile communication protocol module, a wireless area network (Wi-Fi) module, an Ethernet module or other wired or wireless communication modules that can be used as TCP/IP communications. The recommendation server 16 further comprises a communication module 161, wherein the communication module 161 comprises one or more of the following communication functions: a mobile communication protocol module, a wireless area network (Wi-Fi) module, an Ethernet module or other wired or wireless communication modules that can be used for TCP/IP communication. The transaction host 14 sends the transaction code S2 by the network to the recommendation server 16 via the transaction communication module 142 and the communication module 161.

In the first embodiment of the present invention, an implementation of the network transmission is as follows: the transaction host 14 using the transaction communication module 142 to connect the Internet or the enterprise intranet via the wired or wireless network, and communicating with the communication module 161 within the recommendation server 16 to establish a network connection. The transaction host 14 can transmit information with the recommendation server 16 via the network connection.

In the first embodiment of the present invention, an implementation of a wireless network transmission is as follows: the first wireless mobile device 12 using the mobile communication module 123 to connect the Internet or the enterprise intranet via the wireless area network or mobile communication protocol network, and communicating with the communication module 161 within the recommendation server 16 to establish a network connection. The first wireless mobile device 12 can wireless transmit information with the recommendation server 16 via the network connection.

In the first embodiment of the present invention, the transaction recommendation URL S3 is an internet URL (URI or URL) data directing to the recommendation servers 16. The internet URL further comprises a transaction recommendation code, wherein, the transaction recommendation code is a code obtained by encoding the transaction code S2 by the recommendation server 16. When the transaction recommended URL S3 is clicked or connected by any user or any network program or device, the recommendation server 16 can obtain the transaction recommendation code comprised in the transaction recommended URL S3. The recommendation servers 16 uses the transaction recommendation code to perform a reverse transaction information query and then obtains the consumer identifier of the first wireless mobile device 12 linked by the transaction recommendation code, the location code linked by the transaction recommendation code, the transaction payment message linked by the transaction recommendation code, and the related information about the treaded commodity or service linked by the transaction recommendation code.

Wherein, the reverse transaction information query is as follows: the recommendation server 16 decoding the transaction recommendation code in reverse to obtain a transaction code S2. The unique consumer identifier corresponding to the first wireless mobile device 12 of the transaction code S2 is the consumer identifier of the first wireless mobile device 12 connected to the transaction recommendation code. The transaction payment message of the transaction code S2 is the transaction payment message linked to the transaction recommendation code. Then, if the transaction identifier of the transaction code S2 is the identification code of the real transaction within the transaction host 14, the recommendation server 16 queries the transaction host 14 by the query transaction record function of the transaction host 14 to obtain the transaction parameters of the transaction identifier. If the transaction identifier of the transaction code S2 is composed of one or more transaction parameters, the recommendation server 16 decodes the transaction identifier to obtain the transaction parameters. The location code within the transaction parameters is the location code of the transaction recommendation code, and the treaded commodity message within the transaction parameters is the related information about the treaded commodity or service linked by the transaction recommendation code.

In the first embodiment of the present invention, an implementation of the recommendation server 16 sends the transaction commended URL S3 to the transaction application 121, which can refer to FIG. 2. The recommendation server 16 sends the transaction recommendation URL S3 to the transaction application 121 of the first wireless mobile device 12 via the wireless network transmission; or the communication module 161 sends the transaction recommendation URL S3 to the transaction communication module 142 of the transaction host 14 via the Internet or the enterprise intranet, and then sends the transaction recommendation URL S3 to the mobile write-off module 122 by the transaction write-off 141, and final the transaction application 121 can obtain the transaction recommendation URL S3 by the mobile write-off module 122.

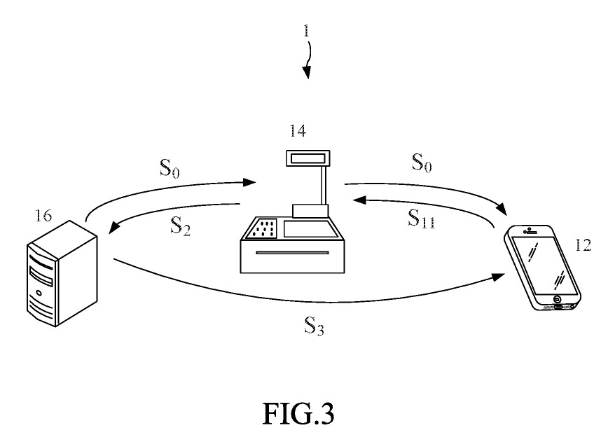

Please refer to FIG. 3. FIG. 3 shows a reverse payment schematic diagram of the first embodiment of the virtual and real market commodity recommendation and reward system 1 of the present invention. In the first embodiment of the present invention, the transaction payment can be a reverse payment in addition to the transaction payment method described above. Wherein, the reverse payment is the recommendation 16 sends the gift vouchers or the electronic point to the first user by the transaction application 121 via the transaction host 14. The reverse payment procedure is as follows: the transaction host 14 sending a gift message S0 via the transaction write-off module 141. The transaction application 121 receives the gift message S0 via the mobile write-off mobile 122, and then sends a consumption message S11 to the transaction host 14 via the mobile write-off module 122. Wherein, the consumption message S11 is confirmed as the gift message S0. The transaction host 14 sends a transaction code S2 to the recommendation server 16, and the recommendation server 16 sends a redeemed voucher to the service account of the first user on the recommendation server 16.

In another embodiment of the present invention, the transaction host 14 can be an electronic commerce system. When the first user purchases the commodity from the electronic commerce system by the browser, the electronic commerce system sends the transaction code S2 to the recommendation server 16 via the Internet while the electronic commerce system is checking the consumption of the first user. The recommendation server 16 sends the transaction recommendation URL S3 to the browser of the first user, and the first user can send the transaction recommendation URL S3 by the sharing mechanism.

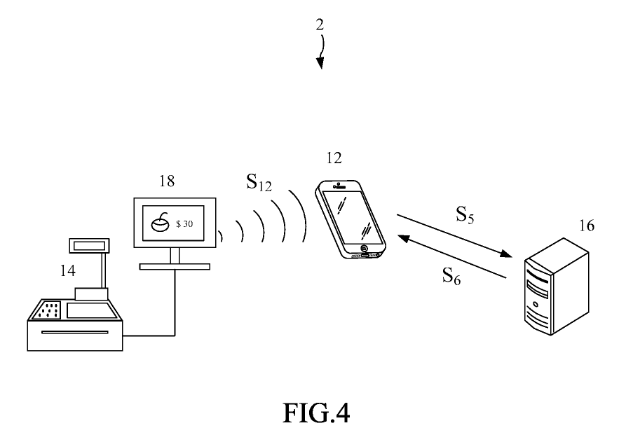

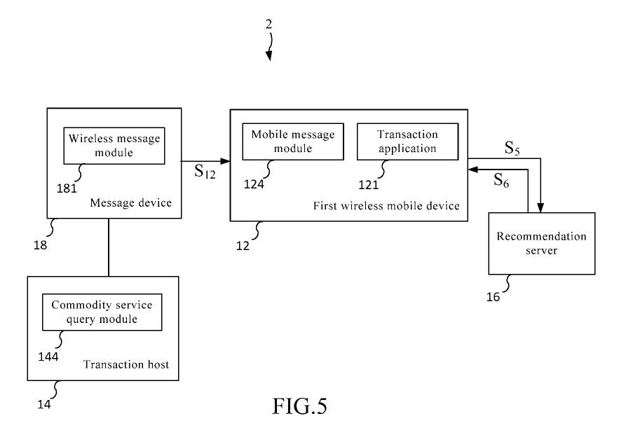

Please refer to FIG. 4 and FIG. 5. FIG. 4 shows a recommendation schematic diagram of the second embodiment of the virtual and real market commodity recommendation and reward system 2 of the present invention, and FIG. 5 shows a recommendation function block diagram of the second embodiment of the virtual and real market commodity recommendation and reward system 2 of the present invention. The virtual and real market commodity recommendation and reward system 2 of the present invention provides at least one first user to recommend a recommended location or a recommended commodity by a sharing mechanism. When at least one second user obtains the recommendation voucher S7 by the sharing mechanism and performs a recommend transaction, the first user can get a reward via the recommended reward mechanism.

In the second embodiment of the present invention, the virtual and real market commodity recommendation and reward system 2 comprises a message device 18, a first wireless mobile device 12, a transaction host 14 and a recommendation server 16. The message device 18 sends a consumption message S12 to the first wireless mobile device 12 by the information exchange. The transaction application 121 receives the consumption message S12 and then sends a consumption code S5 by the wireless network to the recommendation server 16. The recommendation server 16 receives the consumption code S5 to generate a consumption recommended URL S6, and sends the consumption recommended URL S6 by the wireless network to the transaction application 121. Wherein, the first user can send the consumption recommended URL S6 to the second user via a media by a sharing mechanism. When the second user receives the consumption recommended URL S6 and completes a recommended transaction by the consumption recommended URL S6, the first user gets a reward.

In the second embodiment of the present invention, the consumption message S12 can comprise any one or more of the following: a location code, and one or more commodity codes. The consumption code S5 comprises a unique consumer identifier corresponding to the first wireless mobile device 12, a location code, and one or more commodity codes, wherein, the location code is the location code of the consumption message S12, the commodity codes are the commodity codes of the consumption message S12, and the commodity codes are the commodity or service identifier provided by the transaction host 14. At the time of transmission, the consumption code S5 can be further encrypted or encoded in a manner conforming to the transmission specification.

Wherein, the transaction host 14 further comprises a commodity service query module 144 for providing a commodity message corresponding to the commodity code to the recommendation server 16 when the recommendation server 16 performs a query. The commodity message is a commodity or service identifier, a commodity or service offer message, a commodity or service name, a commodity or service provider name, quantity, unit price and other commodity related message within the transaction host 14.

In the second embodiment of the present invention, the first wireless mobile device 12 comprises a mobile message module 124, wherein, the mobile message module 124 has a wireless communication function. The message device 18 comprises a wireless message module 181, wherein, the wireless message module 181 has a wireless communication function, and the message device 18 can store one or more consumption message S12. The message device 18 comprises a message setting function, and the message setting function can modify the consumption message S12 stored in the message device 18. The code comprised in the consumption message S12 can be a factory default value or a code set by a first wireless mobile device 12 through the information exchange to the message device 18 to set the consumption information S12 through the message setting function.

In the second embodiment of the present invention, the wireless communication function of the mobile message module 124 and the wireless message module 181 is selected from one of the following communication methods: Bluetooth, wireless local area network, NFC cards, NFC reads, two-dimensional bar code (QR Code) display, two-dimensional bar code (QR Code) scanning, or other similar wireless network communication modules. In the practical application, the transaction application 121 of the first wireless mobile device 12 exchanges information with the wireless message module 181 via the mobile message 124 by the wireless communication method. The wireless message module 181 sends the consumption message S12 to the first mobile device 12 to follow up the recommended action.

The embodiment of the information exchange of the present invention is as follows: the transaction application 121 of the first wireless mobile device 12 establishes a wireless information exchange channel with the wireless message module 181 via the mobile message module 124 to transmit the message.

In the second embodiment of the present invention, the communication method of the wireless information exchange channel between the mobile message module 124 and the wireless message module 181 is as follows: if the wireless information exchange channel performs in the Bluetooth method, the mobile message module 124 and the wireless message module 181 are the Bluetooth mobile module and the Bluetooth endpoint module, respectively. If the wireless information exchange channel performs in the wireless area network method, the mobile message module 124 and the wireless message module 181 are the Wi-Fi mobile module and the Wi-Fi endpoint module, respectively. If the wireless information exchange channel performs in the NFC cards method, the mobile message module 124 and the wireless message module 181 are the NFC cards mobile module and the NFC reads endpoint module, respectively. If the wireless information exchange channel performs in the NFC reads method, the mobile message module 124 and the wireless message module 181 are the NFC reads mobile module and the NFC cards endpoint module, respectively. If the wireless information exchange channel performs in the QR Code method, the mobile message module 124 and the wireless message module 181 are the display mobile module and the camera endpoint module, respectively. If the wireless information exchange channel performs in the QR Code scans method, the mobile message module 124 and the wireless message module 181 are the camera mobile module and the display endpoint module, respectively.

In the second embodiment of the present invention, the consumption recommendation URL S6 is an internet URL (URI or URL) data directing to the recommendation servers 16. The internet URL further comprises a consumption recommendation code, wherein, the consumption recommendation code is a code obtained by encoding the consumption code S5 by the recommendation server 16. When the consumption recommended URL S6 is clicked or connected by any user or any network program or device, the recommendation server 16 can obtain the consumption recommendation code comprised in the consumption recommended URL S6. The recommendation server 16 uses the consumption recommendation code to perform a commodity information query and then obtain the consumer identifier of the first wireless mobile device 12 linked by the consumption recommendation code, the location code linked by the consumption recommendation code, and the related information about the treaded commodity or service linked by the consumption recommendation code.

Wherein, the commodity information query is as follows: the recommendation server 16 decoding the consumption recommendation code in reverse to obtain a consumption code S5. The unique consumer identifier corresponding to the first wireless mobile device 12 of the consumption code S5 is the consumer identifier of the first wireless mobile device 12 connected to the consumption recommendation code. The location code of the consumption code S5 is the location code linked by the consumption recommendation code. The recommendation server 16 can use the commodity code of the consumption code S5 to query the commodity service query module 144 of the transaction host 14 via the network to obtain the commodity information corresponding to the commodity code. The commodity information is the related information about the treaded commodity or service linked by the consumption recommendation code.

In the present invention, a method of establishing a service account will be described in the following paragraphs.

The first way is as follows: when a user executes the transaction application 121 on the mobile device, the transaction application 121 connects to the recommendation server 16 via a wireless network and transmits the user's consumer identifier to the recommendation server 16; and a service account is established by the recommendation server 16. The service account is linked to the consumer identifier of the user, and can be registered by an account code corresponding to the service account.

The second way is as follows: when a user executes the transaction application 121 on the mobile device, the user is authenticated by using the API (Application Programming Interface) provided by the network media, and then creates an account code corresponding to the service account. The account code is connected with the account of the network media or the login API.

The third way is as follows: the recommendation server 16 comprises a website providing any user registration an account. The account can be selected the account code by the user or generated an account code by the system.

The fourth way is as follows: when a user uses an account to log in to the network media, the account is authenticated by API and connected to the account code. When the user uses the mobile device to execute the transaction application, the account is linked to the consumer identifier of the user. The method of establishing a service account is not limited to the above-described embodiments and any method having similar means, functions and effects to establish the service account are within the scope of the claims of the present invention.

In the present invention, a realization of the sharing mechanism will be described in the following paragraphs.

The first way is as follows: a recommended URL, which can be the transaction recommended S3 or the consumption recommended URL S6. The first user uses the transaction application 121 or the recommendation server 16 to spread the recommended URL by the e-mail to the other user's e-mail address except for the first user. Wherein, the Email protocols such as IMAP (Internet Message Access Protocol), POP3 (Post Office Protocol—Version 3), SMTP (Simple Mail Transfer Protocol), or Microsoft Exchange Server, or use HTTP Email such as Gmail, Hotmail, Yahoo Email, or Microsoft Outlook series.

The second way is as follows: the recommended server 16 is provided to the first user login via an open API, URL, or other authentication methods of a network media. After the authentication processes, the first user or the recommendation server 16 sends the recommended URL to the other user's network media account except for the first user.

The third way is as follows: the recommended server 16 is provided to the first user login via an open API, URL, or other authentication methods of a network media. After the authentication process, the first user or the recommendation server 16 posts a recommended URL to the exclusive page of the first user of the network media. Wherein, the exclusive page can be a personal page, personal home page, personal message board, send text, reply, tweet, sticker, message board, bulletin board, graffiti wall or other personal announcement of the way.

The fourth way is as follows: the user transmits the recommended URL to the transaction application 121 of the other wireless mobile device via the recommendation server 16, or any sharing mechanism that has similar means, functions, and effects to the sharing mechanisms described above.

In the present invention, a network media can be a community website, a community communication software, an instant messaging software, a mobile communication network, an electronic bulletin board, a blog, an electronic map having an evaluation or a message function, a website or discussion group with an evaluation or message function such as Facebook, twitter, Line, Google+, Plurk, Weibo, WeChat, Linkedin, Skype, Sapchat, WhatsAPP, QQ, Blooger, Reddit, Ameba, Tumblr, Instagram, google map, iPeen, Tripadvisor, Yelp, mobile newsletters, or other community sites and web apps with similar functionality.

In the present invention, a transaction information displayed procedure is as follows: when the second user receives the recommended URL and clicks on any wireless mobile device or browser to open or connect the commended URL, the recommendation server 16 can obtain information of the recommended URL and decodes the information to obtain a recommended code. The recommendation server 16 performs a recommendation analysis based on the recommendation code to obtain the recommended commodity options and the service account of the first user linked by the recommended transaction, wherein, the recommended commodity options comprises the recommended commodity name, trade offer information, commodity price and other information, and displays the recommended commodity options and a request voucher hyperlinked in the browser page or trading application 121. The request voucher hyperlinked is a hyperlink connected to the recommendation server 16.

In the present invention, the recommended voucher S7 is obtained as follows: the second user can obtain the commodity information such as the commodity or service name, the trade offer information, the commodity price, of the recommended URL by the transaction information; and, when the request voucher hyperlinked is clicked on the page of the browser or the transaction application 121, the recommendation server 16 sends the recommended voucher S7 to the service account of the second user on the recommendation server 16. In the above procedure, if the second user does not have a service account, it is necessary to register an account by the transaction application 121 of the mobile device or by the website provided by the recommended server 16.

In the present invention, the second user can obtain the recommended voucher S7 to the service account by using the request recommended voucher S7 procedure. The second user uses the transaction application 121 of the mobile device to obtain the recommended voucher S7 of the service account of the second user from the recommendation server 16 via the wireless network, and uses the recommended voucher S7 to perform a recommended transaction to the real shopping or the network, and then the first user can receive a reward after the recommendation transaction is completed

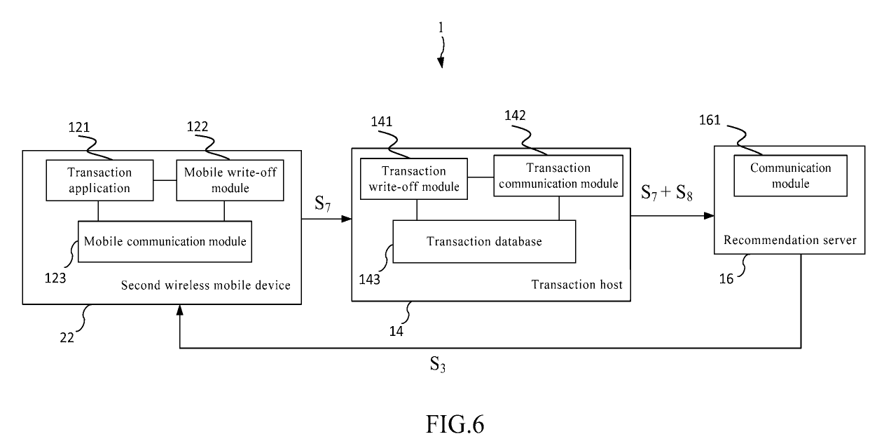

Please refer the FIG. 6. FIG. 6 shows a reward function block diagram of the first embodiment of the virtual and real market commodity recommendation and reward system 1 of the present invention. The reward mechanism of the present invention will be described in the following paragraphs.

The first way is following as: when the second user is trading in the real, the transaction application 121 of the second wireless mobile device 22 uses the mobile write-off module to connect the transaction write-off module of the transaction host 14, and sends the recommended voucher S7 to the transaction host 14. The transaction host 14 sends the recommended voucher S7 to the recommended server 16 via the network, and then the transaction host 14 performs a recommended transaction with the second consumer. After the referral transaction is completed, the transaction host 14 sends the transaction completion notice S8 to the recommendation server 16 via the network, and the recommended server 16 sends a recommended reward voucher to the service account of the first user linked by the recommended transaction.

The second way is following as: the recommendation server 16 further comprising a web e-commerce service. An online consumer who has a service account for the recommendation server 16 can log into the web e-commerce service for consumption, wherein, if the online consumer has more than one recommended voucher S7, the hyperlink of the recommended voucher S7 will be displayed on the webpage when the online consumer is browsing the web e-commerce service. When the online consumer clicks the hyperlink of the recommended voucher S7, the recommendation server 16 reads the recommended voucher S7 in the service account of the online consumer corresponding to the recommended voucher hyperlink, and obtains the recommended code within the recommended voucher S7. Then, a recommended transaction is initiated, and after the recommendation transaction is completed, the recommendation server 16 sends a recommendation reward voucher to the service account of the first user linked by the recommended transaction.

The third way is as follows: the recommendation server 16 further comprises a set of recommended reward API, and the recommended reward API provides a user identity, a recommendation voucher S7 confirmation, a recommendation voucher S7 linked to offer information, recommended commodity options, transaction confirmation and other functions. When an online consumer performs an online transaction on an e-commerce service website, wherein, the e-commerce service website can be PCHome shopping street, PCHome online shopping, Yahoo Mall, Yahoo auction, Amazon, eBay or other similar online shopping websites. The online consumer can use the recommended voucher S7 when using the e-commerce service website at a checkout via a collaborative recommendation hyperlink. The collaborative recommendation hyperlink provides the online consumer to sign in to the recommended server 16 via the recommended reward API, wherein, if the online consumer has more than one recommended voucher S7, the recommendation server 16 displays the hyperlink of the recommended voucher S7. When the online consumer clicks the hyperlink of the recommended voucher S7, the recommendation server 16 reads the recommended voucher S7 in the service account of the online consumer corresponding to the recommended voucher hyperlink, and obtains the recommended code within the recommended voucher S7. Then, the recommendation server 16 displays a recommended commodity option and sends the commodity option information to the e-commerce service via the recommended reward API. When the e-commerce service website completes a recommended transaction, the e-commerce service website informs the recommendation server 16 via the recommended reward API. Then, the recommendation server 16 sends a recommended reward voucher to the service account of the first user linked by the recommended transaction.

The fourth way is as follows: the recommendation server 16 further comprises an e-commerce portal. An online consumer who has a service account for the recommendation server 16 can log into the e-commerce portal, wherein, if the online consumer has more than one recommended voucher S7, the e-commerce portal displays more than one recommended transaction option. The consumer can choose an electricity business website that provides network transaction after choosing the recommended transaction. Then, the recommended server 16 sends a recommended commodity option to the electricity business website via a set of recommended reward API, and the online consumer can perform a recommended transaction via the electricity business website. When the recommended transaction is completed, the electricity business website informs the recommendation server 16 via the recommended reward API. Next, the recommendation server 16 sends a recommended reward voucher to the service account of the first user linked by the recommended transaction, or any recommended reward mechanism with similar means, functions and effects as described above.

In the present invention, a recommended transaction is as follows: a second consumer in a physical store, an web e-commerce service of the recommendation server 16, or an e-commerce service website uses the recommended voucher S7 owned by the second consumer to perform a specify transaction. The subject of the specify transaction comprises one or more recommended commodity options linked by the recommended transaction, the recommended commodity option linked by the recommended transaction and the service account of the first user linked by the recommended transaction, and the specify transaction is obtained by the recommendation server 16 using the recommendation code within the recommendation voucher S7 via the recommendation analysis.

The recommended server 16 further comprises a location database for recording location code, location coordinates, location names, affiliated enterprises, affiliated systems and other information, and the recommended server 16 further comprises a location query module for providing a record of the location database at the time of the location query.

The recommendation server 16 further comprises a commodity database for recording the commodity code, the commodity service name, the trade offer information, the commodity price, the applicable location and other information, and the recommended server 16 further comprises a commodity query module for providing a record of the commodity database at the time of the commodity query, wherein, the information in the commodity database can be imported by the transaction host 14.

The procedure for the recommended analysis in the present invention is as follows: the recommendation server 16 further comprises a recommended commodity database for recording one or more recommended commodity information. The recommended commodity information comprises a link commodity code, a link location code, one or more commodity codes and location code of the recommended commodity option, wherein, the link commodity code can correspond to one or more commodities, and the link location code can correspond to one or more locations. The recommendation server 16 can use the recommended voucher S7 to obtain a recommendation code. If the recommendation code is a transaction recommendation code, the recommended server 16 can use the transaction recommendation code to perform a reverse transaction information query to the obtain consumer identifier of the first wireless mobile device 12 linked by the transaction recommendation code, the location code linked by the transaction recommendation, and the information related the transaction commodity or the service linked by the transaction recommendation code. The service account in the recommendation server 16 corresponding to the consumer identifier of the first wireless mobile device 12 is the service account of the first user who is linked by the recommended transaction. If the recommendation code obtained by the recommendation server S7 is a consumption recommendation code, the recommended server 16 can use the consumption recommendation code to perform a commodity information query to the obtain consumer identifier of the first wireless mobile device 12 linked by the transaction recommendation code, the location code linked by the transaction recommendation, and the information related the transaction commodity or the service linked by the transaction recommendation code. The service account in the recommendation server 16 corresponding to the consumer identifier of the first wireless mobile device 12 is the service account of the first user linked by the recommended transaction. The recommendation server 16 uses the commodity code of the location code and the information related to the transaction commodity or service to perform the database query in the recommended commodity database. If the link commodity code of the recommended commodity information matches the link commodity code of the information related to service or the link location code of the recommended commodity information matches the location code, the recommended commodity option of the recommended information is the recommended commodity option linked by the recommended commodity obtained by the recommended analysis. The recommendation server 16 obtains the commodity code and the location code of the recommended commodity option by using the location code and the information related to the commodity code to perform a database query in the recommended commodity information database. Then, the recommendation server 16 queries the location database to obtain the applicable location name for recommended commodity option. The recommendation server 16 queries the recommended commodity database to obtain information such as the name of the commodity service, the trade offer information, the price of the commodity, the applicable location for the recommended commodity option.

The recommended commodity options can be one of the following: specify commodity options, specify location options, or specify location and commodity options. Wherein, the manual setting method is as follows: the recommendation server 16 provides a recommended commodity setting module for providing a user input interface, and a system administrator can use the user input interface to set the link commodity code, the link location code and the recommended commodity option of a recommended commodity. The recommended commodity setting module can also be configured on the transaction host 14. After the system administrator is set up, the transaction host 14 sends the recommended commodity information to the recommended commodity database of the recommendation server 16 via the network.

The recommendation server 16 further comprises an automatic recommendation setting module for providing an automatic setting interface, and a system administrator can use the automatic setting interface to set the recommended commodity information base on an automatic rule. The automatic rule can set the recommended commodity option according to a location, wherein, the location can be a physical store, and the recommended commodity option can be one or more combination of commodities or the commodities for the physical stores. The recommended commodity options can also be a combination of the commodity or a commodity for stores, wherein, the stores represent anyone or more stores of the chain store or an affiliated business store. The location can also be a website, and the recommended commodity option can be a combination of commodities or a commodity of the website. The automatic rule can also set the recommended commodity option according to a commodity, and the recommended commodity option can be the same commodity, the combination of the same commodities, other commodities of the same brand or a combination of commodities or combinations of different brands or the combination of the same type of commodities. The automatic recommendation setting module can also be configured on the transaction host 14. After the system administrator is set up, the transaction host 14 sends the recommended commodity information to the recommended commodity database of the recommendation server 16 via the network.

If the recommended commodity option is a specific location option or a specific location and commodity option, the second consumer needs to use the browser or the transaction application 121 of the mobile device to send a location verification information via the wireless network to the recommendation server 16, and the recommendation server 16 confirms whether the location verification information matches the specific location to determine whether the recommendation transaction is completed. The location verification information can be a GPS coordinate, wherein, the transaction application 121 of the mobile device owned by the second user reads the GPS information of the mobile device to get the GPS coordinate. The location verification information can be a location code, wherein, the transaction application 121 of the mobile device receives the consumption message S12 of the message device to obtain the location code.

In the present invention, when the recommendation server 16 confirms that the sharing mechanism is transmitted, the recommendation server 16 can send a sharing reward voucher to the service account of the first user to facilitate the use of the sharing mechanism. When the recommended URL is clicked, opened or triggered by the network address of the non-first user network address, the recommendation server 16 can receive the link request of the recommended URL to confirm that the sharing mechanism is completed; or when the recommendation server 16 sends an e-mail and receives the message of the transfer completely or successfully from the e-mail agreement, the sharing mechanism is confirmed to be completed; or when the recommended server 16 sends a recommended URL via the API of a network media and receives the return value of completion or success from the API, the sharing mechanism is confirmed to be completed; or the recommendation server 16 publishes the recommended URL via the API of a network media and receives the return value of completion or success from the API, the sharing mechanism is confirmed to be completed; or when the first user open privacy setting for providing the recommendation server 16 to check the recommended URL is published on the first user's exclusive page via the specific account of the network media, the sharing mechanism is confirmed to be completed.

In the present invention, when the recommendation server 16 performs a recommend transaction, the recommendation server 16 can send a recommendation transaction reward voucher to the service account of the second user in addition to the offer of the recommendation option to promote the recommended voucher S7 request and use.

In the present invention, the recommended reward voucher, the recommended transaction reward voucher and the sharing reward voucher are the exchange voucher. The first user can use the recommended reward voucher via the transaction application 121 to exchange the commodities or services using at the physical store or in the web mall. Wherein the recommendation server 16 can further comprises a voucher exchange API, the transaction host 14 can call the voucher exchange API via the network when the transaction is paid. Wherein, the API comprises a consumer identifier or a service account. The recommendation server 16 receives the API call and confirms the redeemable voucher based on the consumer identifier or the service account, and returns the redeemable bonus to the transaction host 14. The redeemable bonus can be electronic money, virtual currency, convertible commodities bonus points, points used to redeem for shopping, commodities coupons, vouchers and other reward mechanisms.

In practice, the transaction host 14 can be a point-of-sale (POS), a self-service vending machine (Kiosk), a vending machine, or other forms of transactions.

In practice, the transaction host 14 can also communicate with the POS and Kiosk via the transaction communication module 142. Through the transaction connection of POS and Kiosk, a transaction status can be sent to the transaction host 14, wherein, the transaction status can be current transaction information such as a successful transaction, a failed transaction, re-processing, or processing. Wherein the POS and Kiosk can use the transaction host 14 to call the recommendation reward interface and the voucher exchange AP via the transaction communication. The recommendation server 16 also uses the transaction host 14 to send the information such as a consumer identity, a recommended commodity, a trade offer, and an exchange bonus via the network transmission to the POS and Kiosk. The transaction-related information of the transaction host 14 can be provided by POS or Kiosk via the transaction communication.

The recommendation server 16 further comprises one or more log files to record the transaction recommended URL S3, the browse record of the consumption recommended URL, the access record, the request record of the recommended voucher S7, and the recommended transaction record, wherein, the log files can be a variety of systems or service log files or database log files within the operating system.

In an embodiment of the present invention, the recommendation server 16 can further comprises a recommended statistical module for analyzing the log files of the recommendation server 16. The recommendation statistics module is used to sort the recommended commodity items from the first user in the record file, wherein, the recommendation communication item can be a transaction recommended URL S3, a consumption recommended URL S6 sent by the first user, a recommended voucher S7 generated by the recommendation of the first user, and a recommended transaction generated by the recommendation of the first user. Then, a sort of ranking of the recommended commodity items for the first user is obtained. The sort ranking comprises the transaction recommended URL S3 browse ranking, the transaction recommended URL S3 access ranking, the consumption recommended URL S6 browse ranking, the consumption recommended URL S6 access ranking, the recommended voucher S7 request ranking and the recommended transaction ranking.

In practice, the above ranking can be applied to an endorsement or recommendation mechanism of a network media, using the recommendation statistics module to obtain the propagation capability of different first users in different electronic media to provide a report to the advertising industry as a reference to the electronic media endorsement or recommendation.

In the above embodiment, the unique consumer identifier of the first wireless mobile device 12 can be the telephone identifier of the first wireless mobile device 12, the SIM card identifier, the telephone number, the identifier provided by the mobile operating system, or an identifier generated by encoding using the above identifier or number, and is generated by the transaction application 121, the recommendation server 16, or the transaction host 14 at the time of the first execution of the transaction application 121 and stored in the first wireless mobile device 12.

In the above-mentioned embodiments, the Bluetooth module can be any Bluetooth protocol defined by the Bluetooth Association, such as a variety of Bluetooth devices like Bluetooth 2.0 protocol, Bluetooth 3.0 protocol, or Bluetooth 4.0 protocol.

In the above-mentioned embodiments, the wireless mobile communication protocol is Release 4, Release 5, Release 6, Release 7, Release 8, Release 9, Release 10, Release 11, Release 12, Release 13, Release 14 of 3GPP Association, or other mobile telecommunications agreements approved by the ITU International Telecommunication Union.

In the above-mentioned embodiments, the encoding, decoding and reverse decoding can be 16 Bit HEX, Base64, URLEncode, AES, DES, 3DES, Camellia, ARIA, RSA, DSS, ECDSA, Kerberosc or no encoding, same input and output, such as the current well-known encoding.

Compared with the prior art, the virtual and real market commodity recommendation and reward system uses a user's experience to share a recommended commodity or a location to a social media; when a friend consumes based on the recommended commodity or location of the sharing mechanism, the user obtains the reward. The virtual and real market commodity recommendation and reward system makes the information circulate effectively and promotes the motive of the shopping by the characteristic of friends' trust.

With the examples and explanations mentioned above, the features and spirits of the invention are hopefully well described. More importantly, the present invention is not limited to the embodiment described herein. Those skilled in the art will readily observe that numerous modifications and alterations of the device can be made while retaining the teachings of the invention. Accordingly, the above disclosure should be construed as limited only by the metes and bounds of the appended claims.

What is claimed is:

1. A virtual and real market commodity recommendation and reward system, for providing at least one first user to recommend a recommended commodity message by a sharing mechanism, wherein, the recommended commodity message comprises a recommended commodity; when at least one second user performs a recommended transaction by using the recommended commodity message, the virtual and real market commodity recommendation and reward system provides a reward to the first user, wherein, the virtual and real market commodity recommendation and reward system comprises:
a first wireless mobile device, having a transaction application executing thereon, for providing the first user to use the transaction application to purchase the recommended commodity and to send a consumption message;
a transaction host, for receiving the consumption message and sending a transaction code after the completion of the recommended commodity transaction; and
a recommendation server, for receiving the transaction code and generating a transaction recommended URL, and sending the transaction recommended URL to the transaction application;
wherein, the first user can send the transaction recommended URL to the second user by the sharing mechanism; when the second user uses the recommended commodity message via the transaction recommended URL to complete the recommended transaction, the first user gets the reward, wherein, the sharing mechanism selectively pushes the transaction recommended URL to the second user or posts the transaction recommended URL on an exclusive page of the network media.

2. The virtual and real market commodity recommendation and reward system of claim 1, wherein the consumption message comprises a unique consumer identifier corresponding to the first wireless mobile device and a transaction payment message.

3. The virtual and real market commodity recommendation and reward system of claim 2, wherein the transaction payment message comprises the message required for a transaction payment mechanism.

4. The virtual and real market commodity recommendation and reward system of claim 2, wherein the transaction code comprises the unique consumer identifier corresponding to the first wireless mobile device, the transaction payment message and a transaction identifier.

5. The virtual and real market commodity recommendation and reward system of claim 1, wherein the first wireless mobile device comprises a mobile write-off module, and the transaction host comprises a transaction write-off module, and the mobile write-off module and the transaction write-off module utilize the Bluetooth, wireless area network, Near Field Communication (NFC) cards, Near Field Communication (NFC) reads, two-dimensional barcode (Quick Response Code, QR Code) displays, QR Code scans, or other wireless network communication modes to transmit, and the transaction application of the first wireless mobile device can send the consumption message to the transaction write-off module via the mobile write-off module.

6. The virtual and real market commodity recommendation and reward system of claim 5, wherein the transaction host comprises a transaction communication module, and the recommendation server comprises a communication module, and the transaction communication module and the communication module utilize the mobile communication protocol module, wireless area network (Wi-Fi) module, Ethernet module or other cable or wireless communication module for TCP/IP communication transmission to transmit, and the transaction code is sent to the communication module via the transaction communication module.

7. The virtual and real market commodity recommendation and reward system of claim 6, wherein the transaction recommended URL is sent from the communication module to the transaction communication module, and the transaction communication module is connected to the transaction write-off module; therefore, the transaction recommended URL is sent to the transaction write-off module from the transaction communication module, and then sent to the mobile write-off module from the transaction write-off module, and finally sent to the transaction application from the mobile write-off module.

8. The virtual and real market commodity recommendation and reward system of claim 1, wherein the first wireless mobile device comprises a mobile communication module that receives the transaction recommended URL of the recommendation server via the mobile communication module.

9. The virtual and real market commodity recommendation and reward system of claim 1, wherein the second user can obtain a recommended voucher via a recommended URL, and utilize the recommended voucher to use the recommended commodity message to complete the recommended transaction.

10. The virtual and real market commodity recommendation and reward system of claim 9, wherein the recommended URL can be the transaction recommended URL.

11. A virtual and real market commodity recommendation and reward system, for providing a first user to recommend a recommended commodity message by a sharing mechanism, wherein, the recommended commodity message comprises a recommended commodity, when a second user performs a recommended transaction by using the recommended commodity message, the system provides a reward to the first user, wherein, the virtual and real market commodity recommendation and reward system comprises:
a message device, for sending a consumption message comprising the recommended commodity message;
a first wireless mobile device, having a transaction application executing thereon, for providing the first user to use the transaction application to receive the consumption message and send a consumption code; and
a recommendation server, for generating a consumption recommended URL after receiving the consumption code and sending the consumption recommended URL to the transaction application;
wherein, the first user can send the consumption recommended URL to the second user by the sharing mechanism, when the second user uses the recommended commodity message via the consumption recommended URL to complete the recommended transaction, the first user gets the reward, wherein, the sharing mechanism selectively pushes the transaction recommended URL to the second user or posts the transaction recommended URL on an exclusive page of the network media.

12. The virtual and real market commodity recommendation and reward system of claim 11, wherein the recommended commodity message comprises a recommended location.

13. The virtual and real market commodity recommendation and reward system of claim 11, wherein the message device can store more than one consumption message, and the message device comprises a message setting function to modify the consumption message stored in the message device.

14. The virtual and real market commodity recommendation and reward system of claim 11, wherein the consumption code comprises a unique consumer identifier corresponding to the first wireless mobile device and a commodity code of the recommended commodity message.

15. The virtual and real market commodity recommendation and reward system of claim 14, further comprising a transaction host to provide the commodity code.

16. The virtual and real market commodity recommendation and reward system of claim 15, wherein the transaction host comprises a commodity service query module, and the recommendation server uses the commodity code to query the transaction host, wherein the commodity service query module provides a commodity message corresponding to the commodity code to the recommendation server at the time of query.

17. The virtual and real market commodity recommendation and reward system of claim 16, wherein the commodity message is selected from one or more of the following information: a commodity or service identifier, a commodity or service offer message, a commodity or service name, a commodity or service provider name, quantity, unit price within the transaction host.

18. The virtual and real market commodity recommendation and reward system of claim 11, wherein the first wireless mobile device comprises a mobile message module, and the message device comprises a wireless message module, and the mobile message module and the wireless message module utilize the Bluetooth, wireless area network, Near Field Communication (NFC) cards, Near Field Communication (NFC) reads, two-dimensional barcode (Quick Response Code, QR Code) displays, QR Code scans, or other wireless network communication modes to transmit, and the wireless message module of the mobile device can send the consumption message to the transaction application via the mobile message module.

19. The virtual and real market commodity recommendation and reward system of claim 11, wherein the second user can obtain a recommended voucher via a recommended URL and utilize the recommended voucher to use the recommended commodity message to complete the recommended transaction.

20. The virtual and real market commodity recommendation and reward system of claim 19, wherein the recommended URL can be the transaction recommended URL.

21. The virtual and real market commodity recommendation and reward system of claim 9 or 19, wherein the recommendation server comprises at least one record file, and the record file comprises a browsing history of at least one recommended URL corresponding to at least one first user, an access record of at least one recommended URL corresponding to at least one first user, a request record of at least one recommended voucher corresponding to at least one second user and a transaction record of at least one recommended transaction corresponding to at least one second user.

22. The virtual and real market commodity recommendation and reward system of claim 21, wherein the recommendation server comprises a recommended statistical module, and the recommended statistical module analyzes at least one record file and sorts a recommended communication item of the record file, wherein the recommended communication item can be the browse ranking of the recommended URL, the access ranking of the recommended URL, the request ranking of the recommended voucher or the ranking of the recommended transaction.

23. The virtual and real market commodity recommendation and reward system of claim 1 or 11, wherein the first user establishes a service account via the recommendation server, and the service account comprises a unique identifier of the first user corresponding to the first wireless mobile device; when the second user uses the recommended commodity message to complete the recommended transaction, a reward message is fed back to the service account of the first user.

24. The virtual and real market commodity recommendation and reward system of claim 1 or 11, wherein the sharing mechanism can use a network of media to recommend the recommended commodity message, and the network of media can be a community website, a community communication software, an instant messaging software, a mobile communication network, an electronic bulletin board, a blog, an electronic map with evaluation or message function, a website with evaluation or message function or a discussion group.
